(19) United States
(12) Patent Application Publication
(10) Pub. No.: US 2010/0071333 A1
(43) Pub. Date: Mar. 25, 2010

(54) LOADING AUGER DEFLECTOR

(76) Inventors: Douglas G. Temple, Fulton, IL (US); Brian J. Tank, East Moline, IL (US)

Correspondence Address: Taylor & Aust, P.C/Deere & Company, P.O. Box 560, Avilla, IN, 46710, US

(21) Appl. No.: 12/234,983

(22) Filed: Sep. 22, 2008

(51) Int. Cl. A01D 41/12; B60P 1/40; A01F 12/46

(52) U.S. Cl. 56/14.6; 414/505; 460/8

(57) ABSTRACT

A clean grain conveyor system for a harvesting machine having grain gathering, cleaning and temporary storage capabilities includes a clean grain elevator mechanism, a grain storage tank and a loading auger conveyor for moving grain from the elevator mechanism to a discharge end at the storage tank. The conveyor includes a hollow generally cylindrical tube extending obliquely upwardly from the elevator to the grain storage tank and a coaxially disposed auger journalled for rotation within the hollow tube. A grain flow deflector is fixed to the tube discharge end for minimizing grain scattering outside the tank and for selectively directing the flow of grain from the tube discharge end to compensate for different crops and crop conditions, and to generally center the pile of accumulated grain within the tank.

### FIELD OF THE INVENTION

The present invention relates to agricultural harvesting machinery and more particularly to a system for conveying crop to a combine grain storage tank.

### BACKGROUND OF THE INVENTION

Agricultural harvesting machines, such as combines, are employed in the agricultural industry for various tasks, including harvesting crops. During harvesting operations, typical such agricultural harvesting machines move through a crop field while operating a header at the front of the harvesting machine to cut the crop. The header cuts and then moves the cut crop into a feeder house and the feeder house transports crop into threshing, separating and cleaning areas of the combine where crop is removed from the non-grain crop materials and then transferred to the harvesting machine's hopper such as a grain tank for temporary storage. When the hopper is full, the combine moves to a transport vehicle such as a large truck or trailer to discharge the load and then resume harvesting. The combine may be used to harvest granular materials such as wheat or rice, beans, corn, various other seeds, or other granular materials, herein generically referred to as grain or crop. In the case of granular materials, clean grain is moved by a clean grain elevator and a grain tank auger to the onboard storage tank and later transferred to a large capacity container for transport and/or storage. Grain exits the discharge end of the auger with considerable inertia and frequently a deflector or shroud at the outlet end of the grain tank loading auger is employed to direct the flow of crop away from the typically open top of the tank. Combines employing these principles are illustrated, for example, in U.S. Pat. Nos. 4,029,228 and 5,695,399.

U.S. Pat. No. 4,029,228 employs a shroud at the loading auger discharge end shaped generally as a semi-cylindrical shell having a closed free end which supports a bearing structure for the rotatable auger flighting. The shroud is fixed as by rivets to the auger tube free end with the open half of the cylinder directed in an obliquely downward direction.

U.S. Pat. No, 5,695,399 similarly shows a shroud at the loading auger discharge end shaped generally as a semi-cylindrical shell, but having an open free end. The open half of the cylinder is directed in an obliquely downward direction. A bearing structure for the rotatable auger flighting is supported on a separate U-shaped strap fixed as by rivets to the auger tube free end. The shroud appears to be of a larger diameter than the auger tube and to be fixed thereto by some sort of bracket structure, but none is disclosed.

Larger loads per trip to the transport vehicle result in a reduction of fuel consumption, operator time and equipment wear. The need for larger grain tanks on combines has driven customers to install after market grain tank extensions to increase the capacity of the grain tank by over 25%. This increases the amount of grain above the discharge point of the loading auger. As the grain accumulates above the discharge end of the loading auger more and more energy is needed to introduce more grain. Also, the flighting of the loading auger wears out prematurely due to the excessive grain above the loading auger. A reduction in the wear experienced and the energy expended in filling the grain tank above the auger outlet is highly desirable.

### SUMMARY OF THE INVENTION

The invention in one form is directed to a grain flow deflector for use in an agricultural harvester of a type for performing threshing and cleaning operations, and presenting clean crop to a conveyor for conveyance to a temporary onboard storage location. The deflector is located near the outlet end of the conveyor for redirecting crop flow and includes first and second interconnected grain flow directing plates. The first plate is rigidly fixed to the outlet end of the conveyor to control scattering of grain primarily while the grain level in the storage location is below the outlet end of the conveyor. The second plate is adjustably fixed to the outlet end of the conveyor and operable to direct grain flow in adjustably selectable directions to compensate for different crops and crop conditions to generally center the pile of accumulated grain within the storage location.

The invention in another form is directed to a harvesting machine for gathering grain from a field, processing the gathered grain and temporarily storing the grain for subsequent transfer to a larger capacity container. The harvesting machine includes a grain storage tank and an auger conveyor with a hollow generally cylindrical tube and a coaxially disposed auger journalled for rotation within the hollow tube to convey grain from a first tube end to a second tube end for discharge into the storage tank. There is a grain deflector fixed to the second tube end having a grain flow diverting plate spaced from the second tube end which is selectively movable between a first position where grain flow is angularly diverted from vertical in a first direction and a second position where grain flow is angularly diverted from vertical in a second direction. The diverting plate is pivotably supported for limited motion about an axis extending transverse to the tube axis. The deflector also has a flange located to one side of the second tube end for confining grain flow to the storage tank which is primarily effective to confine grain flow while the grain level in the tank is below the second tube end.

### BRIEF DESCRIPTION OF THE DRAWINGS

FIG. 1 is a side elevation view of a self-propelled agricultural combine;

FIG. 2 is a cross-sectional view along lines 2-2 of FIG. 1;

FIG. 3 is an isometric view of the loading auger and grain deflector of FIG. 2 with the grain flow diverting plate in the left position;

FIG. 4 is an isometric view of the loading auger and grain deflector of FIG. 2 with the grain flow diverting plate in the right position;

FIG. 5 is an isometric view of the loading auger and grain deflector of FIG. 2 with the grain flow diverting plate in the center position; and

FIG. 6 is a graph of power consumption vs. grain tank accumulation comparing the present invention to prior deflector configurations;

### DETAILED DESCRIPTION OF THE INVENTION

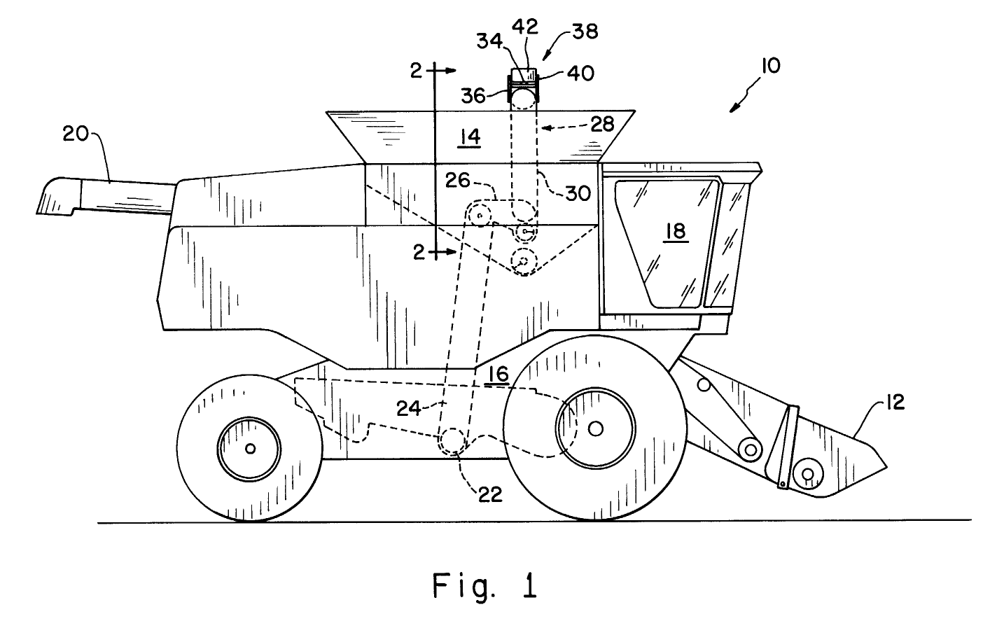

Referring now to FIG. 1, there is schematically shown an agricultural work machine 10 in accordance with an embodiment of the present invention. In the present embodiment, agricultural harvesting machine 10 is in the form of a self-powered combine including a supporting structure 16 having wheels supporting a frame. It will be understood that the present invention is applicable to other types of agricultural harvesting machines, self-powered or otherwise.

Combine 10 may include a header (not shown) attached to a feeder house 12, a hopper or grain tank 14 which functions as a temporary on-board storage location, a hopper unloading system indicated generally at 20, and a cab 18 for housing the operator of the harvesting machine. The header may be configured in known manner to cut the crop being harvested, which is then transferred to threshing, separating and cleaning assemblies (not shown) that separate the agricultural product, e.g., grain, from the chaff. Chaff may exit the combine at the rear of the machine. The feeder house 12 is a conveyor for directing the harvested crop material to the threshing, separating and cleaning assemblies located within the combine. Hopper 14 is configured to receive and temporarily store the agricultural product during harvesting operations after the separating and cleaning operations.

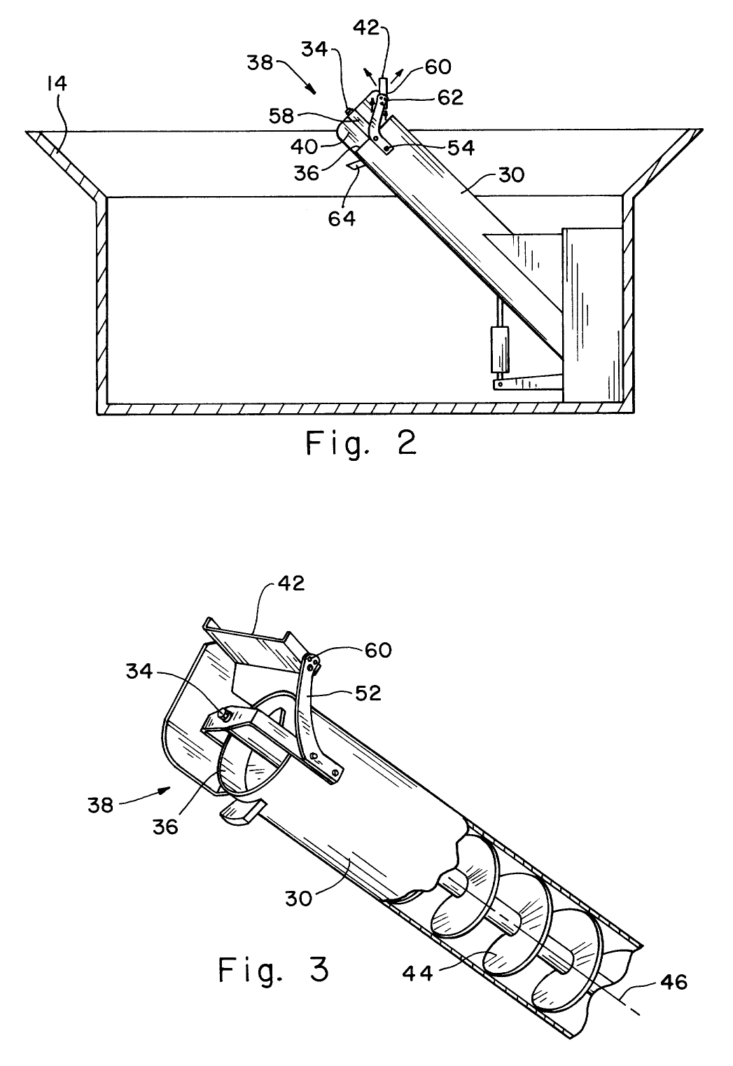

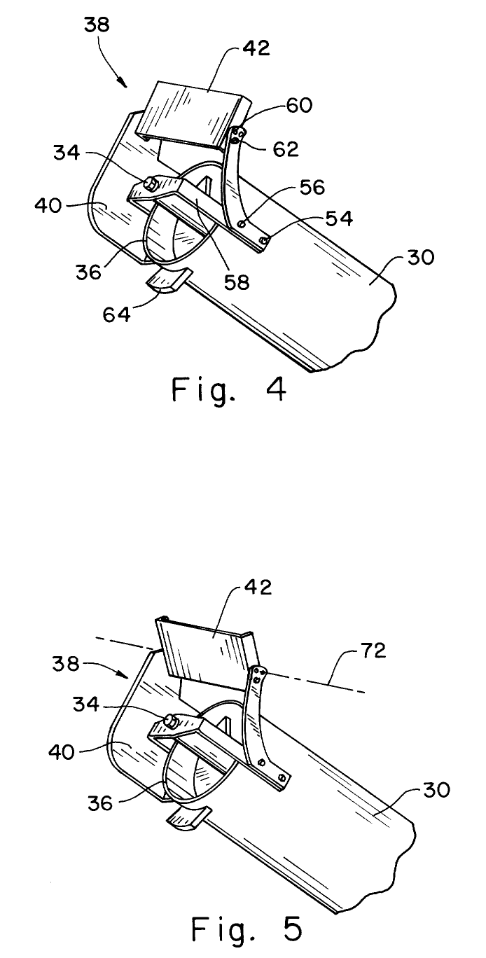

A cross auger 22 directs the clean grain to one side of the combine to the sump of the clean grain elevator 24. The clean grain elevator 24 lifts the clean grain up to a transition housing 26 containing a loading auger sump. The cross auger, elevator and transition housing make up a clean grain elevator mechanism. Clean grain entering the transition housing 26 is directed upwardly into the center of the grain tank 14 by an obliquely upwardly extending loading auger conveyor 28. The loading auger conveyor (often called a screw conveyor) includes a tube 30 containing an auger or flighting. The tube is provided with a bearing assembly or journal 34 at its outlet end 36 for rotatively mounting the flighting in the tube 30. The tube may be of the movable type shown in U.S. Pat. No. 5,695,399 where the flighting is driven by a coupling (not shown) which automatically disengages when the tube 30 is lowered into a transport position, and automatically engages when the tube is raised into its working position. A rest 64 (FIGS. 2 and 4) engages an unloading cross auger housing (not shown) when the tube is lowered for transport. Alternately, a floating auger of known design may be employed which raises or lowers as the grain level in the tank changes.

Referring now to FIGS. 2-5, auger 44 is journalled at the outlet end 36 by the bearing assembly 34 for rotation about the auger axis 46. The bearing assembly 34 is supported by a bracket 58 which, in turn, is fixed to the tube 30 by rivets or other suitable fasteners 54 and 56 and a similar pair of fasteners on the tube opposite side. The pair of fasteners not visible in FIGS. 2-5 also pass through and fix the flange 40 to the tube. Similarly, fasteners 54 and 56 also pass through and support an angle bracket 52. The deflector 38 includes a flange 40 located to one side of the tube outlet or discharge end 36 and a generally flat angled bracket 52 having a pair of legs extending from one another at an obtuse angle. One bracket leg is fixed to the tube on a side opposite the flange 40 and another bracket leg extends obliquely away from the tube providing near its free end a first pivot location for the flow diverting plate 42. Flange 40 provides the second pivot location for the flow diverting plate.

The deflector 38 at the outlet end 36 of the loading auger directs the flow of crop to remain within the tank and to control how the grain pile builds. Different crops and crop conditions affect the way in which the grain pile builds and the deflector may be employed to center the grain pile in the tank. The deflector flange 40 functions as a flow directing plate to keep grain from being flung outside the as grain enters the tank. The flange is located to one side of the auger discharge end 36 as determined by the pitch and direction of auger rotation. Modification of the geometry of the discharge or outlet end 36 may require a change in the shape or location of the flange 40. The deflector also supports a flow directing blade or plate 42 which may be selectively positioned to divert grain flow to ward the left (FIG. 3), toward the right (FIG. 4) or upward in a central position as seen in FIG. 5.

The flow directing or diverting plate is generally rectangular in shape having a length about the same as the tube diameter. A pivotal axis 72 extends along the length of the rectangle about midway between the opposed plate edges. The flow diverting plate 42 may be formed from a flat generally rectangular metal sheet which has been bent upward ninety degrees at two opposing ends. The ends support outwardly extending pivot pins such as 60 which define the pivot axis 72. Comparing FIGS. 3 and 5 it is apparent that the plate 42 is supported for pivotal motion about axis 72 which lies generally orthogonal to the direction of grain flow exiting the tube discharge end. The pivotal axis 72 is offset from the tube axis 46 by about the tube radius.

The pins such as 60 are received in pivot location determining holes in the flange 40 and angle bracket 52. Rivets or other suitable members may be substituted for the pins. A second pin extending from one plate end engages an arcuate slot 60 in the angled bracket 52 which determines the extent of possible pivotal motion. Friction may suffice to secure the plate in a selected position. Friction may be augmented by interengaging dimples in a plate end and in the corresponding bracket 52 or flange 40. A tightenable wing nut or more sophisticated detent scheme may be employed.

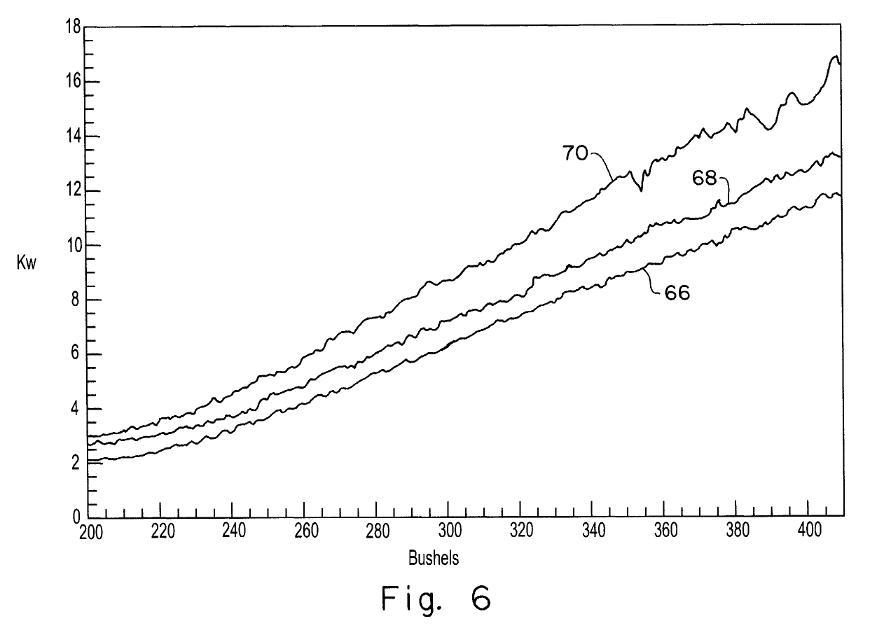

As grain continues to enter the tank 14, the level will eventually cover the outlet end 36 of the auger conveyor and introduction of additional grain is primarily upward against the weight of the overlying grain. Once the outlet end 36 is submerged in grain, the power required to continue rotation of auger 44 increases dramatically as illustrated in FIG. 6. That figure shows power required in kilowatts as ordinate and grain quantity as abscissa. The auger discharge end 36 just becomes covered at the 200 bushel point. When employing a deflector of the type shown in U.S. Pat. No. 5,695,399 grain exits in an obliquely downward direction forcing tank grain outwardly then upwardly. Tests with this style auger yielded the plot 70 in FIG. 6. Removing the deflector entirely and allowing grain to flow freely from the discharge end eases the burden of pushing grain out of the way and significantly reduces the additional power requirements as illustrated by plot 66, however, undesirable scattering of grain outside the tank 14 may occur prior to the discharge end becoming covered. Test results for the present invention with the grain deflector configured and positioned to minimize the additional power required, due to the presence of the deflector, to introduce further grain into the tank when the grain level in the tank is above the second tube end are shown by the intermediate plot 68. Assuming a fairly constant rate of grain transfer, the area between plots 68 and 70 represents the total energy saving for each full load of grain.

Having described the preferred embodiment, it will become apparent that various modifications can be made without departing from the scope of the invention as defined in the accompanying claims.

1-7. (canceled)

8. A grain flow deflector for use in an agricultural harvester of a type for performing threshing and cleaning operations, and presenting clean grain to a conveyor for conveyance to a temporary onboard storage location, the deflector located near the outlet end of the conveyor and comprising:
first and second interconnected grain flow directing plates, the first plate rigidly fixed to the outlet end of the conveyor and operable to control scattering of grain, and the second plate adjustably fixed to the outlet end of the conveyor and operable to direct grain flow in adjustably selectable directions.

9. The grain flow deflector of claim 8, wherein the first plate is effective to control scattering of grain primarily while the grain level in the storage location is below the outlet end of the conveyor, and the second plate is effective to compensate for different crops and crop conditions by directing grain flow to generally center the pile of accumulated grain within the storage location.

10. The grain flow deflector of claim 8, wherein the deflector is configured and positioned to minimize the additional power required, due to the presence of the deflector, to introduce further grain into the storage location when the outlet end of the conveyor becomes submerged beneath accumulated grain.

11. The grain flow deflector of claim 8, wherein the second plate is supported for pivotal motion about an axis generally orthogonal to the direction of grain flow exiting the outlet end of the conveyor.

12. The grain flow deflector of claim 8, wherein the storage location comprises a grain tank and the conveyor comprises a hollow generally cylindrical tube and a coaxially disposed auger journalled for rotation within the hollow tube to convey grain from a first tube end to a second tube end for discharge into the grain tank.

13. A clean grain conveyor system for a harvesting machine having grain gathering, cleaning and temporary grain storage capabilities, comprising:
a clean grain elevator mechanism;
a grain storage tank;
a loading auger conveyor including a hollow generally cylindrical tube extending obliquely upwardly from the elevator to the grain storage tank and a coaxially disposed auger journalled for rotation within the hollow tube to convey grain from the elevator mechanism to a tube discharge end for discharging grain into the storage tank; and
a grain flow deflector fixed to the tube discharge end for minimizing grain scattering outside the tank and for selectively directing the flow of grain from the tube discharge end to compensate for different crops and crop conditions, and to generally center the pile of accumulated grain within the tank, the deflector including first and second interconnected grain flow directing plates, the first plate rigidly fixed to the tube discharge end and operable to control scattering of grain, and the second plate adjustably fixed to the tube discharge end and operable to direct grain flow in adjustably selectable directions.

14. (canceled)

15. The clean grain conveyor system of claim 13, wherein the second plate is supported for pivotal motion about an axis generally orthogonal to the direction of grain flow exiting the tube discharge end, said pivotal axis being offset from the tube axis by about the tube radius.

16. The clean grain conveyor system of claim 12, wherein the second plate is generally rectangular in shape having a length about the same as the tube diameter, said pivotal axis extending along the length of the rectangle about midway between the opposed plate edges.
